(19) United States
(12) Patent Application Publication
(10) Pub. No.: US 2005/0081002 A1
(43) Pub. Date: Apr. 14, 2005

(54) Memory system and method of managing a memory system

(75) Inventors: Naehyuck Chang, Seoul (KR); Hojun Shim, Seoul (KR); Yongsoo Joo, Ulwang-si (KR); Yongseok Choi, Seoul (KR); Hyung Gyu Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/962,406

(22) Filed: Oct. 13, 2004

(30) Foreign Application Priority Data
Oct. 14, 2003 (KR) 2003-71425

(51) Int. Cl. G06F 12/00

(52) U.S. Cl. 711/154; 711/118; 711/105; 711/156

(57) ABSTRACT

A method to reduce consumption of static and dynamic energy in a memory system. The method efficiently reduces dynamic and static energy consumed by the memory system by analyzing factors including characteristics of application programs, hardware performance, and the state of memory address buses, which may affect energy consumption, and by controlling a memory device based on the analysis.

### CROSS-REFERENCE TO RELATED APPLICATION

This application claims the priority of Korean Patent Application No. 2003-71425, filed on Oct. 14, 2003 in the Korean Intellectual Property Office, the disclosure of which is incorporated herein in its entirety by reference.

### BACKGROUND OF THE INVENTION

1. Field of the Invention

The present invention relates to a method to manage a memory system to reduce energy consumption, and more particularly, to a method to reduce consumption of static and dynamic energy used when information related to an application program, a central processing unit (CPU) core, a cache module, a memory, etc., is stored in the memory system.

2. Description of the Related Art

Generally, application programs are becoming increasingly sophisticated. As application programs become sophisticated, application programs require more memory transactions, which results in a higher consumption of energy. As computing capacity of mobile systems, such as cellular phones, etc., increases, sophisticated application programs that were once operable only in desktop computers can now be run in mobile systems powered by batteries. Therefore, an amount of energy consumed by memory systems in mobile systems, which determines how long the mobile systems can be used, for example, is partly determined by the number of memory transactions required for an application program.

In this regard, it has become important to reduce power consumption of memory systems in mobile systems. Accordingly, various methods have been studied to reduce the power consumption of memory systems. One of these methods is an optimization method using a power consumption model rather than a cost function model. However, it is difficult to implement the power consumption model in reality because the power consumption model is based on a simple energy model and fails to consider interactions between memory address buses, bus drivers, memory devices, etc.

For example, until now, a simple capacitance model has been used for memory cells and system buses or a transit has been used as a standard to measure power consumption. Even peripheral devices have been regarded as capacitive loads when measuring power consumption.

Generally, the energy consumption of synchronous dynamic random access memory (SDRAM) devices may be determined by how frequently the SDRAM is accessed. It assumes that a predetermined amount of energy is consumed each time the SDRAM is accessed. However, main memory systems, such as dynamic random access memories (DRAMs) and static random access memories (SRAMs), may be a major source of power consumption rather than cache memories. Therefore, if such a simple power consumption model is used, it is likely that inappropriate method to reduce energy consumption will be produced as a result. Therefore, it is preferable that a device level access protocol (DLAP) is considered.

In addition, a memory controller that controls an SDRAM device puts a memory address bus in a low state (represented by “0”) when the memory address bus is idle. Some memory controllers maintain a value to reduce the number of bit changes in the state of the memory address buses, thereby reducing energy consumption caused by a hamming distance that results from change of values indicating the state of memory address buses.

However, this method to reduce energy consumption only decreases consumption of dynamic energy and fails to reduce the consumption of static energy by memory address buses, such as LVT type buses, which are widely used in SDRAM devices. Further, these memory address buses have little effect on reduction of energy consumption since most of the memory address buses are in the idle state.

Accordingly, an aspect of the present invention provides a method to efficiently reduce energy, and particularly, a method to reduce dynamic and static energy consumed by a memory system by analyzing factors including characteristics of application programs, performance of hardware, state of memory address buses, etc., which may affect energy consumption, by controlling a memory device and address buses thereof based on the analysis.

### SUMMARY OF THE INVENTION

According to an aspect of the present invention, a method to reduce energy consumption of a memory system is provided. The method comprises: detecting present state information of a computing system that uses the memory system, receiving predetermined policy condition information, selecting an energy policy from an auto pre-charge policy and an active page policy based on the present state information and the predetermined policy condition information, and transmitting a control signal corresponding to the energy policy to a memory device of the memory system.

According to an aspect of the present invention, the present state information includes central processing unit (CPU) information, where each CPU information and the policy information includes any one of a number of commands that a CPU core processes over a predetermined period of time, for example per an hour, and an operating clock frequency. According to an aspect of the present invention, the present state information further includes cache information, where each cache information and the policy condition information includes a cache memory hit ratio. The cache memory hit ratio is determined by any one of and/or a combination of information related to a size of a cache index, a degree of relation between cache and memory, a size of a cache block, and a characteristic of an application program.

According to another aspect of the present invention, a method to reduce energy consumption of a memory system includes, extracting memory reference pattern information of an application program that uses the memory system, selecting an energy policy from an auto pre-charge policy and an active page policy based on the memory reference pattern information, and transmitting a control signal corresponding to the energy policy to a memory device of the memory system.

According to an aspect of the present invention, extracting the memory reference pattern information includes determining whether memory addresses referred to by a write and/or a read command are consecutive. Further, according to an aspect of the present invention, the active page policy is selected when consecutive addresses are referred to by the memory reference pattern information, and the auto pre-charge policy is selected when consecutive addresses are not referred to by the memory reference pattern information.

According to another aspect of the present invention, a method to reduce energy consumption of a memory system includes: detecting a non-transaction period during which there is no memory transaction, receiving a predetermined first critical clock count from an energy policy, and changing a mode of a memory from an active mode to an idle mode based on the non-transaction period and the predetermined first critical clock count.

According to an aspect of the present invention, the method further includes receiving a predetermined second critical clock count, and changing the mode of the memory into a power shutdown mode based on the non-transaction period and the second critical clock count.

According to an aspect of the present invention, the first critical clock count is determined by any one of and/or a combination of a memory reference pattern of an application program and performances of a CPU core, a cache module, and a memory device.

According to another aspect of the present invention, a method to reduce energy consumption of a memory system includes, extracting bus state information of a memory address bus, generating a bus control signal to cause the memory address bus to be in a high state while the memory address bus is in an idle state, and maintaining the memory address bus in the high state in response to the bus control signal.

According to another aspect of the present invention, a memory system is provided. The memory system comprises: a policy determiner to generate a policy select signal used to select an energy policy based on present state information and policy condition information, a memory controller to receive the policy select signal and to generate a control signal to control a memory according to an energy policy, where a mode of a memory device is changed according to the energy policy in response to the control signal. The present state information and the policy condition information include any one of and/or a combination of memory reference pattern information, CPU information, cache information, and memory device information.

### BRIEF DESCRIPTION OF THE DRAWINGS

The above and/or other aspects and advantages of the invention will become apparent and more readily appreciated from the following description of the preferred embodiments, taken in conjunction with the accompanied drawings of which:

FIG. 1 is a block diagram of a memory device generally used in a computing system;

FIG. 2 is a state diagram to illustrate mode changes of a synchronous dynamic random access memory (SDRAM);

FIG. 3 is a block diagram of a memory device to illustrate a method to reduce energy consumption of a memory according to an aspect of the present invention;

FIG. 4 is a block diagram of a policy determiner according to an aspect of the present invention;

FIG. 5 is a flowchart to illustrate a method to select an energy policy using memory pattern information according to an aspect of the present invention;

FIG. 6 is a flowchart to illustrate a method to select an energy policy based on the performance of a cache according to an aspect of the present invention;

FIG. 7 is a block diagram of a policy determiner according to another aspect of the present invention;

FIG. 8 is a flowchart to illustrate a method to select an energy policy based on a critical clock count according to another aspect of the present invention; and

FIG. 9 is a flowchart to illustrate a method to select an energy policy based on a state of a memory address bus according to another aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Throughout the specification, the term ‘energy policy’ denotes a method to control a memory device by changing a state of a memory device into a specified state, to a mode under a specified condition, and/or by using a specified control signal. The energy policy includes a combination of specified control signals generated by a memory controller to change the state of the memory device into a specified state and/or to a mode depending on specifications of a memory cell. Further, ‘select an energy policy’ is used to signify that a specified standard signal is generated to generate a combination of specified memory control signals.

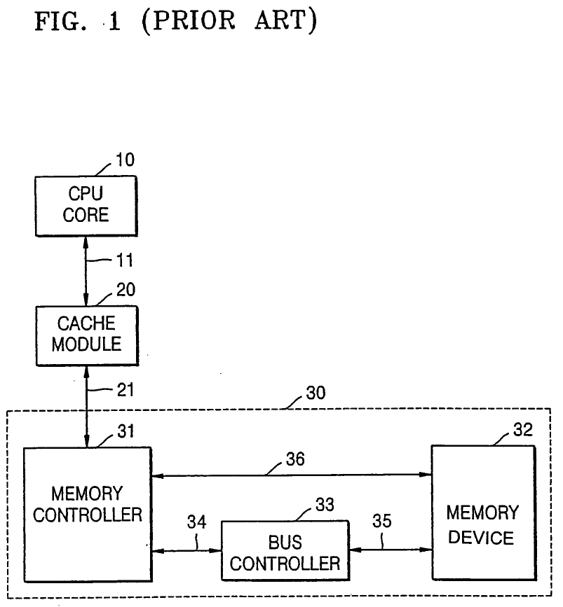

FIG. 1 is a block diagram of a memory device generally used in a computing system. The memory device includes a CPU core 10, a memory system 30, and a cache module 20. The CPU core 10 performs computations that are related to an application program. The memory system 30 stores data necessary to compute and/or computing results, and transmits the data and/or the computing results from/to the CPU core 10. The cache module 20 provided between the CPU core 10 and the memory system 30 temporarily stores frequently used data and/or command languages.

The memory system 30 includes a memory controller 31, a memory bus 35, a bus controller 33, and a memory device 32. The memory controller 31 changes a mode of the memory device 32 according to specifications of the memory device 32, thereby enabling data transactions between the CPU core 10 and the memory device 32. In order to change the mode of the memory device 32 appropriately, a control signal 36 is transmitted to the memory device 32. Data written to and/or read from the memory device 32 using the control signal 36 is transmitted to the CPU core 10 via the memory bus 35, the bus controller 33, a bus control signal 34, and the memory controller 31.

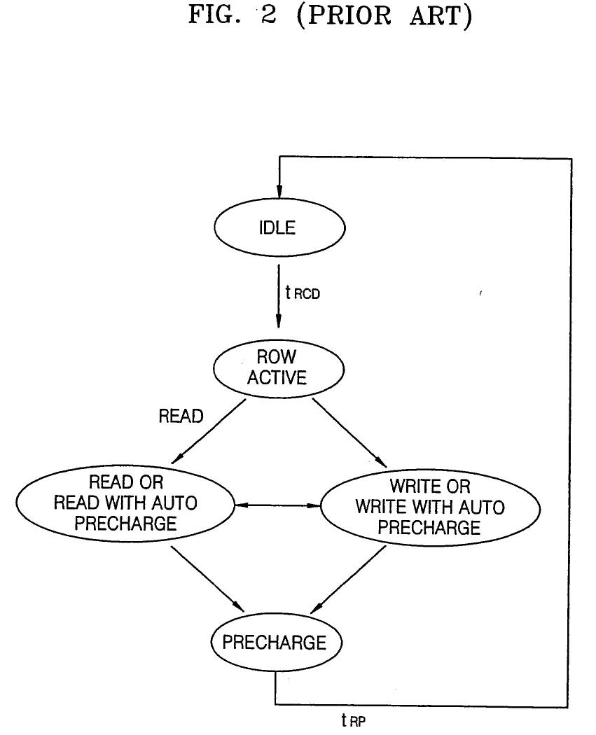

FIG. 2 is a state diagram to illustrate mode changes of a synchronous dynamic random access memory (SDRAM). The mode of the SDRAM is classified into ‘idle’, ‘row active’, ‘write/read’, and ‘pre-charge’. A change of modes is determined by the control signal 36 transmitted from the memory controller 31 to the memory device 32. The control signal 36 is determined by a combination of various input pins including /CAS, /RAS, /WE according to the specifications of the memory device 32. The combination of these signals is often called a command.

The SDRAM is in the idle mode when a pre-charge command is completed and a sense amp has no data. When a row activate command is input to the SDRAM when the SDRAM is idle, one row of one bank is enabled. When data is latched in the sense amp after a predetermined period of time, the bank enters the row active mode. After being in the row active mode, the bank enters the write/read mode and the data stored in the sense amp of the bank may be burst written/read after inputting a command to the bank, such as a read command, a read with auto pre-charge command, a write command, a write with auto pre-charge command, etc. This is the write/read mode. After the write/read operation is complete, the bank, automatically or in response to a pre-charge command, enters the pre-charge mode.

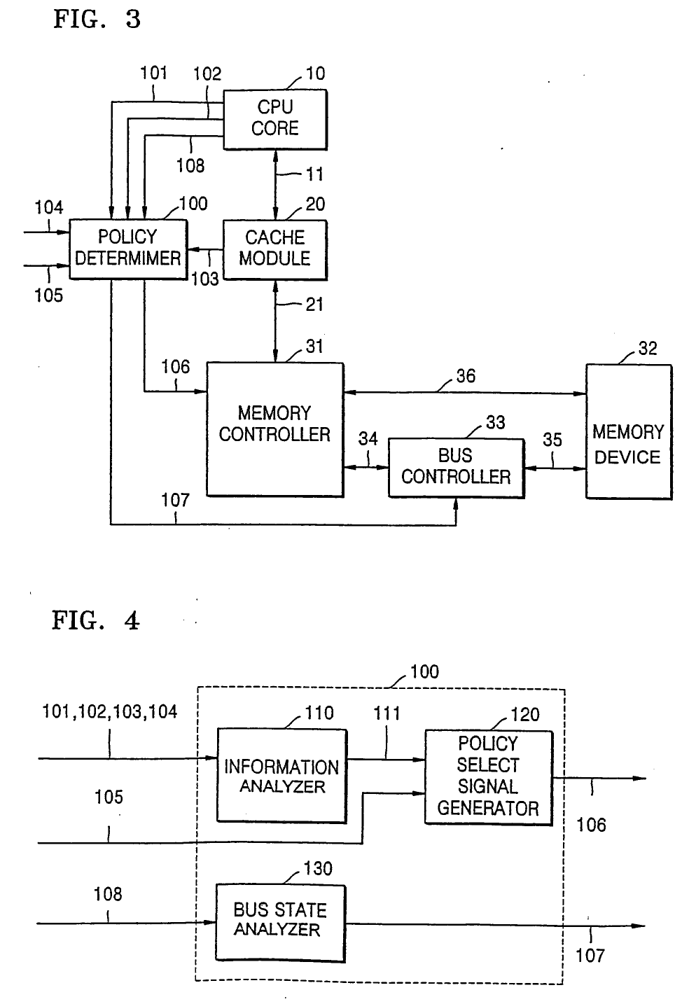

FIG. 3 is a block diagram of a memory device to illustrate a method to reduce energy consumption by a memory according to an aspect of the present invention. The memory device further includes a policy determiner 100 that changes an energy policy of the memory controller 31 and the bus controller 33 based on information, such as a memory reference pattern of an application program.

The policy determiner 100 receives pattern information 101 and CPU information 102 from the CPU core 10, cache information 103 from the cache module 20, or memory information 104 and policy condition information 105 input from a user. The policy determiner 100 generates a policy select signal 106 or a bus control signal 107 to indicate an energy policy to be used.

The pattern information 101 indicates a pattern according to which addresses the application program refers to in the memory device 32. When the CPU core 10 transmits a write/read command to the memory device 32, the pattern information 101 indicates whether corresponding physical addresses of the memory device 32 are consecutive or not.

When the addresses of the memory device 32 are consecutive, an active page policy is selected since consecutive row hits are likely to occur in the active mode. When the application program does not continuously access consecutive addresses, an auto pre-charge policy is selected since a row miss is likely to occur in the active mode.

When the consecutive addresses are to be accessed, the policy determiner 100 generates a policy select signal 106 corresponding to the active page policy and transmits the policy select signal 106 to the memory controller 31. When consecutive addresses are not to be accessed, the policy determiner 100 generates the policy select signal 106 corresponding to the auto pre-charge policy and transmits the policy select signal 106 to the memory controller 31.

The memory controller 31 generates a control signal 36 to change the mode of the memory device 32 appropriately for each condition. The control signal 36 selects the active page policy or the auto pre-charge policy in response to the policy select signal 106 generated by the policy determiner 100.

When the policy select signal 106 indicates the auto pre-charge policy, the control signal 36 generated by the memory controller 31 indicates that the mode of the SDRAM is to be changed from active to idle whenever the write/read operation is completed. In other words, the write/read operation of the SDRAM is terminated after a burst write/read operation is completed, and then the bank enters the pre-charge mode.

According to an aspect of the present invention, the control signal 36 is one of various timing signals depending on the specification of the memory device 32. For example, when a burst write/read with auto pre-charge command is input to a 16M SDRAM, the burst write/read operation is performed when the input of an A10 pin of the memory device 32 is at a logic high. In this case, timing signals tRAS and tRP are generated. The bank is automatically pre-charged in response to the timing signals after the completion of the burst write/read operation and the SDRAM is returned to the idle mode. Generally, the burst write/burst read operation is performed when the input of the A10 pin of the memory device 32 is at a logic low. Thus, the bank remains active after the burst write/read operation is complete.

When the policy select signal 106 selects the active page policy, the bank remains active even after the write/read operation is complete. In other words, the control signal 36 generated by the memory controller 31 is a combination of timing signals that makes the bank active until a ‘pre-charge command’ is input to the memory system 30.

According to an aspect of the present invention, an energy policy is determined based on various factors including the memory reference pattern of the application program. Further, the CPU information 102 includes the number of commands that the CPU core 10 processes over a predetermined period of time and/or an operating clock frequency of the CPU core 10. When the CPU operating clock frequency is low, it is beneficial to change the mode of the memory device 32 from active to idle whenever performing the write/read operation (auto pre-charge policy). When the CPU operating clock frequency is high, it is beneficial, in terms of energy consumption, to maintain the memory device 32 in an active state even after the write/read operation is performed (active-page policy).

Cache information 103 includes a cache memory hit ratio. When the cache memory hit ratio is low, the active page policy that keeps the SDRAM active should be selected since there is a high probability of a transaction between the cache module 20 and the memory device 32 in a short period of time. When the cache memory hit ratio is high, it is beneficial to select the auto pre-charge policy since there is a low probability of a transaction between the cache module 20 and the memory device 32 in a short period of time. The cache memory hit ratio is affected by such factors as the size of a cache index, a degree of relation between cache and memory, the size of a cache block, etc. Therefore, these factors may be measured and analyzed.

The cache information 103 includes information regarding whether a cold cache miss occurred or whether a working set of the application program is loaded in the cache module 20. According to an aspect of the present invention, when the cold cache miss occurs, the active page policy is used, and when the working set of the application program accumulates, the auto pre-charge policy is used.

According to an aspect of the present invention, the CPU core 10, the cache module 20, and the memory device 32 may provide the CPU information 102, the cache information 103, and the memory information 104 to the policy determiner 100 via a separate measuring device (not shown). A user may also input the CPU information 102, the cache information 103, and the memory information 104 to the policy determiner 100.

Generally, a memory address bus 35 of the memory system 30 remains idle. When the memory address bus 35 is idle, the state of the memory address bus 35 is determined by a bus control signal 34 transmitted from the memory controller 31 to the bus controller 33. The memory controller 31 generates the bus control signal 34 to maintain the memory address bus 35 in a high state for each bit while the memory address bus 35 is idle. Energy consumption is greater when the memory address bus 35 remains in a low state than when the memory address bus 35 remains in a high state. Hence, it is possible to reduce the consumption of static energy, which is the largest portion of the energy consumed by the memory address bus 35.

FIG. 4 is a block diagram of a policy determiner according to an aspect of the present invention. The policy determiner 100 includes an information analyzer 110, a policy select signal generator 120, and a bus state analyzer 130.

The information analyzer 110 receives the pattern information 101, the CPU information 102, the cache information 103, and the memory information 104, and generates present state information 111. The present state information 111 is used to determine the energy policy. The present state information 111 may be, for example, a look-up table created as a result of the combination of the pattern information 101, the CPU information 102, the cache information 103, and the memory information 104. According to an aspect of the present invention, based on the pattern information 101, the CPU information 102, the cache information 103, and the memory information 104, a user establishes the present state information 111 including factors that the user intends to reflect in an energy policy or considers important. For example, when a user intends an energy policy to reflect only the CPU information 102, the present state information 111, the user includes only the CPU information 102.

The policy select signal generator 120 receives the present state information 111 and the policy condition information 105, compares the present state information 111 with the policy condition information 105, and generates a policy select signal 106 that meets a condition determined by the policy condition information 105. Similar to the present state information 111, the policy condition information 105 may be a look-up table including factors that a user intends to reflect in an energy policy. When the present state information 111 and the policy condition information 105 are look-up tables and when a factor in each of the look-up tables satisfies a specified condition, the policy select signal 106 to select a policy corresponding to the factor is generated.

The bus state analyzer 130 reflects the state of the memory address bus 35 in an energy policy. The bus state analyzer 130 receives a bus state signal 108 that indicates the period when the memory address bus 35 is idle during a memory transaction, and generates a bus control signal 107 that maintains the memory address bus 35 in a high state during the corresponding period.

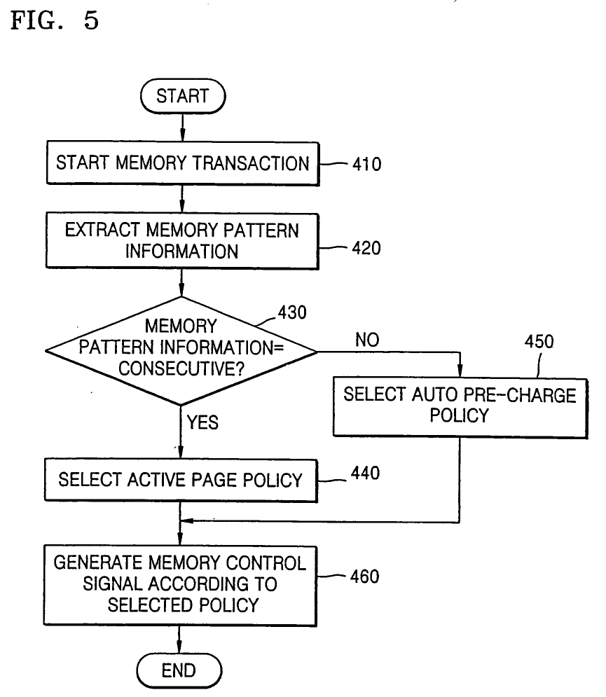

FIG. 5 is a flowchart to illustrate a method to select an energy policy using memory pattern information according to an aspect of the present invention.

When a memory transaction is started between the CPU core 10 and the memory device 32 (operation 410), a write/read command is transmitted from the cache module 20 to the memory controller 31. The information analyzer 110 of the policy determiner 100 extracts memory addresses included in the write/read command and transmits the memory addresses to the policy signal generator 120 (operation 420). The policy select signal generator 120 determines whether the memory addresses received from the information analyzer 110 are consecutive (operation 430). When the memory addresses received from the information analyzer 110 are consecutive, the policy select signal generator 120 generates the policy select signal 106 that indicates the active page policy (operation 440). When the memory addresses received from the information analyzer 110 are not consecutive, the policy select signal generator 120 generates the policy select signal 106 to indicate the auto pre-charge policy. The memory controller 31 receives the policy select signal 106, generates the control signal 36, and transmits the control signal 36 to the memory device 32 (operation 460).

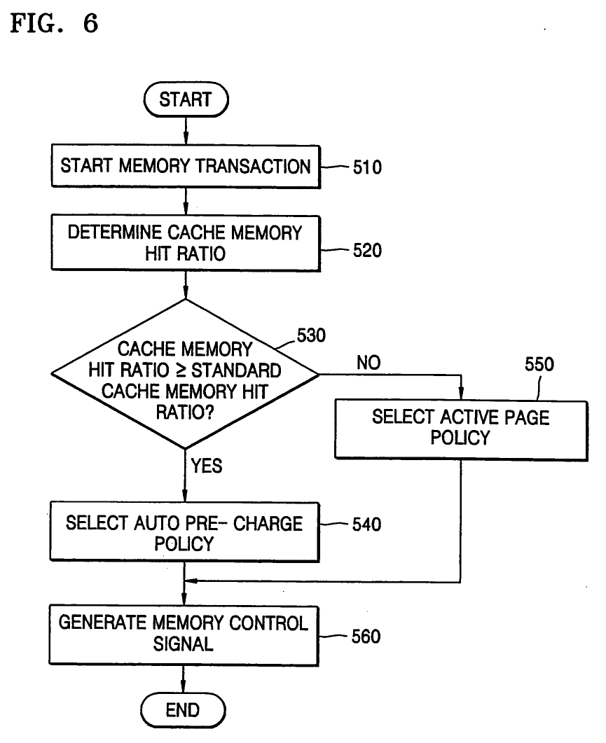

FIG. 6 is a flowchart to illustrate a method to select an energy policy depending on the performance of a cache according to another aspect of the present invention.

When a memory transaction is started between the CPU core 10 and the memory device 32 (operation 510), the information analyzer 110 determines a cache memory hit ratio by determining whether a write/read command of the memory transaction issued by the CPU core 10 accesses the memory device 32 and/or the cache module 20 (operation 520).

The policy select signal generator 120 receives the cache memory hit ratio from the information analyzer 110 and a standard cache memory hit ratio from the policy condition information 105 input by a user and compares the same (operation 530). When the cache memory hit ratio is greater than the standard cache memory hit ratio, the policy select signal generator 120 generates the policy select signal 106 to indicate the auto pre-charge policy (operation 540). When the cache memory hit ratio is less than the standard cache memory hit ratio, the policy select signal generator 120 generates the policy select signal 106 to indicate the active page policy (operation 550).

The memory controller 31 receives the policy select signal 106, generates the memory control signal 36, and transmits the control signal 36 to the memory device 32 (operation 560).

The operation of determining an energy policy based on the CPU information 102 and/or the memory information 104 in this case is similar to the operation described above. The policy condition information 105 input by a user includes the cache information 103 as well as the CPU information 102 and the memory information 104 regarding specifications of the CPU core 10 and the memory device 32. The cache information 103, the CPU information 102, and the memory information 104 are compared with information input by a user. As a result of the comparison, the policy select signal 106 is generated.

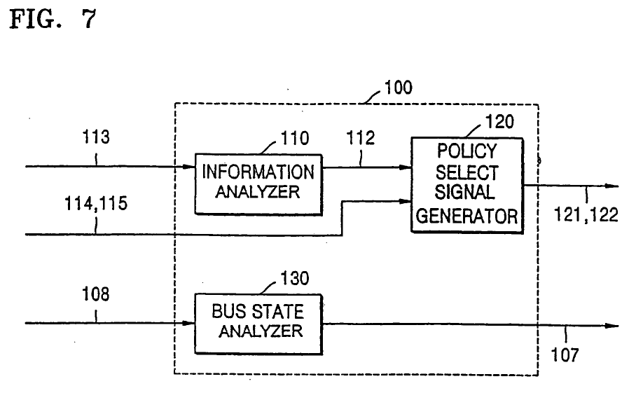

FIG. 7 is a block diagram of a policy determiner according to another aspect of the present invention.

An apparatus to reduce energy consumption of the memory devices 32 uses a delayed pre-charge policy. The delayed pre-charge policy detects whether there is a memory transaction during a critical period and changes the mode of the memory device 32 from active to idle or from idle to power shutdown when there is no memory transaction, that is, when there is no request for the write/read operation. The critical period is determined by policy information including reference pattern information of an application program and the performance of a CPU core 10.

An energy policy is determined based on a critical period because a row hit is very likely to occur when a memory transaction is within a short period of time, and a row miss is very likely to occur when a memory transaction is made within a long period of time.

An information analyzer 110 analyzes a write/read command 113 transmitted from the cache module 20 and detects a non-transaction period 112 during which there is no write/read command. A policy select signal generator 120 receives a first critical clock count 114 and a second critical clock count 115, and compares the first critical clock count 114 and the second critical clock count 115 with a non-transaction period 112. When the length Tnt of the non-transaction period 112 is greater than the length T1 of first critical clock count 114, the policy select signal generator 120 generates an idle mode policy signal 121, and the non-transaction period 112 continues. When the length Tnt of the non-transaction period 112 becomes greater than the length T2 of the second critical clock count 115, the policy select signal generator 120 generates a power shutdown mode policy signal 122. When the memory controller 31 receives the idle mode policy signal 121, the memory controller 31 generates the control signal 36 to change the mode of the memory device 32 from the active mode to the idle mode. When the memory controller 31 receives the power shutdown mode policy signal 122, the memory controller 31 generates the control signal 36 to change the mode of the memory device 32 to the power shutdown mode.

The greater the length T1 of the first critical clock count 114, the higher the row hit ratio that is generated when controlling memory. However, a high row hit ratio does not necessarily result in a reduction of energy consumption. Therefore, caution should be exercised when determining the length T1 of the first critical clock count 114. That is, even though the row hit may eliminate a pre-charge cycle and a row active cycle, thereby reducing dynamic energy consumption, more static energy is consumed to maintain the memory device 32 in the active mode while the memory address bus 35 is idle for the sake of the row hit.

In this regard, when the memory controller 31 uses the delayed pre-charge policy, the first critical clock count 114 should be determined by taking into account the memory reference pattern of the application program, the operating frequency of the CPU core 10, the cache memory hit ratio of the cache module 20, distribution of the idle mode, and distribution of the row hit operation according to the operating clock frequency of the memory device 32.

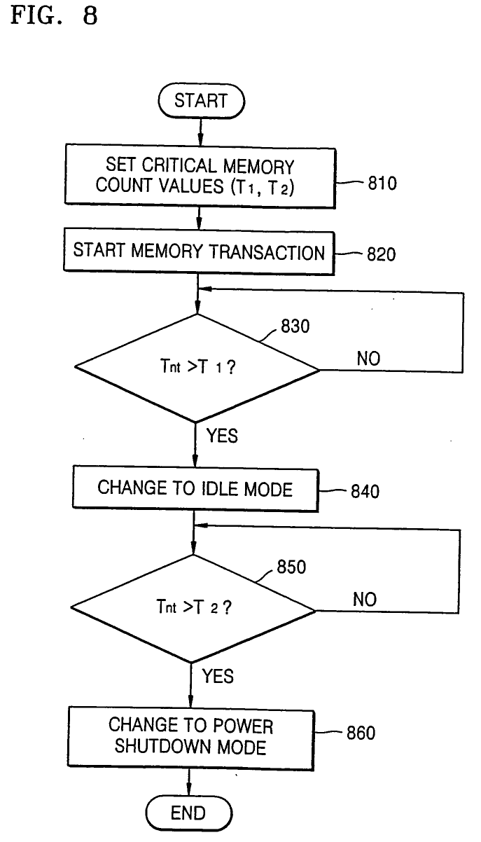

FIG. 8 is a flowchart to illustrate a method to select an energy policy based on a critical clock count according to another aspect of the present invention.

A user inputs the first and the second critical clock counts 114 and 115 to the policy determiner 100 (operation 810). When a memory transaction starts between the CPU core 10 and the memory device 32, the information analyzer 110 of the policy determiner 100 receives and analyzes the write/read command 113, and detects the non-memory transaction period 112 (operation 820). The policy select signal generator 120 receives the non-transaction period 112 and the first critical clock count 114, and compares the length Tnt of the non-transaction period 112 and the length T1 of the first critical clock count 114 (operation 830). When the length Tnt of the non-transaction period 112 is greater than the length T1 of the first critical clock count 114, the policy select signal generator 120 generates the idle mode policy signal 121. Then, the memory controller 31 generates the control signal 36 to change the mode of the memory device 32 from the active mode to the idle mode, and transmits the control signal 36 to the memory device 32. Then, the memory device 32 changes to the idle mode (operation 840).

When a memory transaction does not occur for a long period of time after the memory device 32 changes to the idle mode, the policy select signal generator 120 generates the power shutdown mode policy signal 122. In other words, after the policy select signal generator 120 compares the second critical clock count 115 and the non-transaction period 112, when the length Tnt of the non-transaction period 112 is greater than the length T2 of the second critical clock count 115, the policy select signal generator 120 generates the power shutdown mode policy signal 122 (operation 850). The memory controller 31 receives the power shutdown mode policy signal 122 and generates the control signal 36 to change the memory device 32 to the power shutdown mode. Then, the memory device 32 receives the control signal 36 and changes to the power shutdown mode (operation 860).

According to an aspect of the present invention, changing the memory device 32 to the power shutdown mode by using the second clock count 115 is performed independent of changing the memory device 32 to the idle mode by using the first clock count 114. In other words, it is possible to skip the operation of comparing the non-transaction period 112 with the first critical clock count 114 and jump to the operation of comparing the non-transaction period 112 with the second critical clock count 115, thereby generating the policy select signal 106 at a level used to change the memory device 32 to the power shutdown mode.

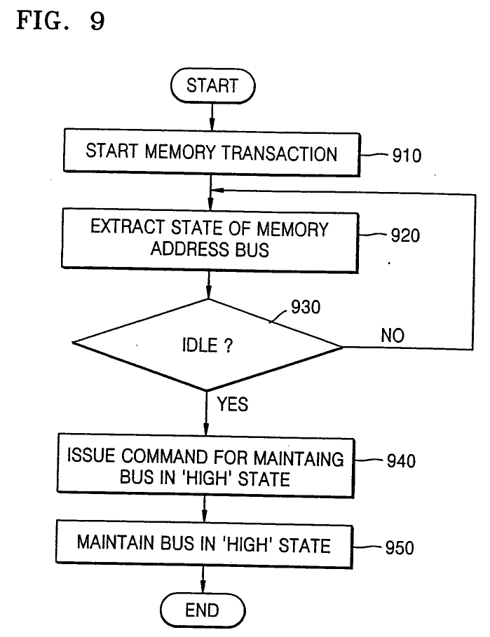

FIG. 9 is a flowchart to illustrate a method to select an energy policy based on the state of a memory address bus according to another aspect of the present invention.

When a memory transaction starts between the CPU core 10 and the memory device 32 (operation 910), the bus state analyzer 130 receives the bus state signal 108 from the CPU core 10 (operation 920) and determines the state of the memory address bus 35 (operation 930). When the state of the memory address bus 35 is idle, the bus state analyzer 130 generates the bus control signal 107 to maintain the memory address bus 35 in a high state (represented by “0”) and transmits the bus control signal 107 to the bus controller 33 of the memory controller 31. The bus controller 33 receives the bus control signal 107 and maintains the memory address bus 35 in the high state (operation 950).

As described above, the present invention provides a method to efficiently reduce energy, and particularly, to efficiently reduce dynamic and static energy consumed by a memory system by analyzing factors including characteristics of application programs, hardware performance, and the state of memory address buses, which may affect energy consumption, by controlling a memory device based on the analysis.

Although a few embodiments of the present invention have been shown and described, it will be understood by those of ordinary skill in the art that various changes may be made in these embodiments without departing from the principles and spirit of the present invention, as defined by the appended claims and their equivalents.

1. A method to manage a memory system of a computing system, comprising:
extracting present state information of the computing system that uses the memory system;
receiving predetermined policy condition information;
selecting an energy policy from an auto pre-charge policy and an active page policy based on the present state information and the predetermined policy condition information; and
transmitting a control signal corresponding to the selected energy policy to a memory device of the memory system.

2. The method according to claim 1, wherein the extracting of the present state information comprises:
extracting central processing unit information, each central processing unit information and the policy information including any one of a number of commands that a central processing unit core processes over a predetermined period of time and an operating clock frequency.

3. The method according to claim 2, wherein the predetermined period of time over which the central processing unit core processes the number of commands is an hour and the selecting of an energy policy comprises:
selecting the active page policy when the number of commands that the central processing unit core processes per the hour and/or the operating clock frequency is greater than a predetermined value stored in the predetermined policy condition information, and
selecting the auto pre-charge policy when the number of commands that the central processing unit core processes per the hour and/or the operating clock frequency is less than the predetermined value stored in the policy condition information.

4. The method according to claim 1, wherein the extracting of the present state information comprises:
extracting cache information, where each cache information and the policy condition information includes a cache memory hit ratio.

5. The method according to claim 4, wherein the selecting of an energy policy comprises:
selecting the auto pre-charge policy when the cache memory hit ratio is greater than a predetermined value stored in the policy condition information and selecting the active page policy when the cache memory hit ratio is less than the predetermined value stored in the policy condition information.

6. The method according to claim 5, wherein the cache memory hit ratio is determined by any one of and/or a combination of information related to a size of a cache index, a degree of relation between cache and memory, and a size of a cache block.

7. The method according to claim 5, wherein the cache memory hit ratio is determined by checking whether a working set of an application program is loaded in a cache module or not.

8. A method to manage a memory system, comprising:
extracting memory reference pattern information of an application program that uses the memory system;
selecting an energy policy from an auto pre-charge policy and an active page policy based on the memory reference pattern information; and
transmitting a control signal corresponding to the selected energy policy to a memory device of the memory system.

9. The method according to claim 8, wherein the extracting of the memory reference pattern information includes determining whether memory addresses that are referred to by a write and/or a read command issued by a cache module of the memory system are consecutive or not.

10. The method according to claim 9, wherein the selecting of an energy policy comprises:
selecting the auto pre-charge policy when the memory reference pattern information refers to non-consecutive addresses, and selecting the active page policy when the memory reference pattern information refers to consecutive addresses.

11. The method according to claim 9, wherein the auto pre-charge policy changes the mode of the memory device from an active mode to an idle mode in response to a pre-charge command, and the active page policy maintains the memory device in an active state.

12. A method to manage a memory system, comprising:
detecting a non-transaction period during which there is no memory transaction;
receiving a predetermined first critical clock count; and
changing a mode of a memory device in the memory system from an active mode to an idle mode based on the non-transaction period and the predetermined first critical clock count.

13. The method according to claim 12, wherein the changing of the mode of the memory to the idle mode comprises:
changing the memory device from the active mode to the idle mode when length of the non-transaction period is greater than length of the first critical clock count.

14. The method according to claim 12, wherein the first critical clock count is determined by any one of or a combination of a memory reference pattern of an application program and performances of a central processing unit core, a cache module, and memory device.

15. The method according to claim 12, further comprising:
receiving a predetermined second critical clock count; and
changing the mode of the memory device to a power shutdown mode based on the non-transaction period and the second critical clock count.

16. The method according to claim 15, wherein the changing of the mode of the memory device into the power shutdown mode includes changing the mode of the memory device into the power shutdown mode when length of the non-transaction time period is greater than length of the second critical clock count.

17. A method to manage a memory system, comprising:
detecting a non-transaction time period during which there is no memory transaction;
receiving a predetermined second critical clock count; and
changing a mode of a memory device in the memory system to a power shutdown mode based on the non-transaction period and the second critical clock count.

18. A method to manage a memory system, comprising:
extracting bus state information of a memory address bus;
generating a bus control signal causing the memory address bus to be in a high state while the memory address bus is in an idle state; and
maintaining the memory address bus in the high state in response to the bus control signal.

19. The method according to claim 12, wherein the changing of the mode of the memory device comprises:
transmitting a control signal to change the mode of the memory device of the memory system, where the control signal is determined based on input pins of the memory device.

20. A method to manage a memory system of a computing system, comprising:
controlling an energy policy of the memory system based on detected present state information of the computing system and predetermined policy condition information; and
transmitting a control signal corresponding to the energy policy to the memory system.

21. A memory system having a memory device, comprising:
a policy determining unit to generate a signal to select an energy policy used by the memory system, the signal being generated based on analysis of pattern information according to which data is written and/or read from the memory and predetermined policy condition information; and
a memory controller to control the energy policy of the memory device based on the signal to select the energy policy from the policy determining unit.

22. The memory system according to claim 21, wherein the predetermined policy condition information is set by a user.

23. The memory system according to claim 21, wherein the pattern information indicates whether memory addresses which the data is written to and/or read from are consecutive, and the policy determining unit selects an auto pre-charge policy when the memory reference pattern information indicates non-consecutive addresses and the policy determining unit selects an active page policy when the memory reference pattern information refers to consecutive addresses.

24. A memory system including a memory device, comprising:
a policy determiner to generate a policy select signal used to select an energy policy based on present state information and policy condition information; and
a memory controller to receive the policy select signal and to generate a control signal to control to the memory device according to the selected energy policy, where the memory device changes mode in response to the control signal.

25. The memory system according to claim 24, wherein the present state information and the policy condition information include any one of and/or a combination of memory reference pattern information, central processing unit information, cache information, and memory device information.

26. The memory system according to claim 24, wherein the policy determiner comprises:
a policy select signal generator to receive the present state information and the policy condition information and compare the present state information and the policy condition information based on which the policy select signal that meets a condition is generated.

27. A memory system having a memory device, comprising:
an information analyzer to determine a cache memory hit ratio by determining whether a write and/or read command issued by a central processing unit accesses the memory device or not; and
a policy select signal generator to receive the cache memory hit ratio from the information analyzer, to receive a standard cache memory hit ratio from policy condition information input by a user, and to compare the cache memory hit ratio and the standard cache memory hit ratio; and
wherein the policy select signal generator generates a policy signal to indicate an auto pre-charge policy when the cache memory hit ratio is greater than the standard cache memory hit ratio, and generates a policy signal to indicate an active page policy when the cache memory hit ratio is less than the standard cache memory hit ratio.
